(19) United States
(12) Patent Application Publication
(10) Pub. No.: US 2016/0295899 A1
(43) Pub. Date: Oct. 13, 2016

(54) STABILIZATION OF HEATED FOOD SUBSTRATES

(71) Applicant: Crisp Sensation Holding S.A., Geneva (CH)

(72) Inventors: Wihelmus Johannes Gerardus Michiels, Ospel (NL); Bianca Van der Kolk, Hertogenbosch (NL)

(73) Assignee: Crisp Sensation Holding S.A., Geneva (CH)

(21) Appl. No.: 15/094,790

(22) Filed: Apr. 8, 2016

Related U.S. Application Data
(63) Continuation-in-part of application No. 14/683,752, filed on Apr. 10, 2015.

(30) Foreign Application Priority Data
Apr. 10, 2015 (EP) 15163191.8

(51) Int. Cl. A23L 3/3562; A23L 1/00

(52) U.S. Cl. CPC A23L 1/3103; A23L 1/3157; A23L 1/0128; A23L 3/3562; A23V 2002/00

(57) ABSTRACT

A method of manufacture of a food product including wholly or partially impregnating an edible substrate that may be meat, poultry, fish, vegetable, fruit or dairy food with a stabilizer composition wherein the stabilizer composition includes: 5 wt % to 30 wt % of one or more gums calculated by weight of dry matter; salt, selected from sodium chloride, potassium chloride and combinations thereof; one or more polyglucose components selected from the group consisting of maltodextrin; polydextrose; starch and combinations thereof; a phosphate component; and optional further edible ingredients.

### CROSS-REFERENCE TO RELATED APPLICATIONS

This application is a continuation-in-part of U.S. patent application Ser. No. 14/683,752 filed on Apr. 10, 2015, the entire disclosure of which is hereby incorporated by reference.

This application also claims foreign priority to European Patent Application Serial No. 15163191.8 filed on Apr. 10, 2015, the entire disclosure of which is hereby incorporated by reference.

### FIELD OF THE DISCLOSURE

This disclosure and/or invention generally relates to food products which are stabilized to retain moisture during cooking or reheating in a microwave or thermal oven. This invention relates particularly but not exclusively to food products comprising a substrate or core and a surrounding coating, for example a breaded or battered product. The invention also relates to non-coated food products and to stabilizer compositions for use in manufacture of such products. The invention further relates to methods of stabilization of the food products. In particular embodiments of the invention the core comprises a meat product, especially whole muscle or bone-in meat.

This invention finds particular but not exclusive application in relation to products which are cooked or reheated in a thermal oven. The products may be also cooked or reheated in a combination microwave-thermal oven, or an air fryer or in a microwave oven.

### BACKGROUND

Many food materials, for example natural muscle of poultry, fish or red meat, vegetable or processed foods contain a large percentage of water. Most fresh foods contain more than 60% water. Some of this water is bound, that is tightly attached to the constituent cells. The remaining mobile water is available and can be frozen. If a food product is frozen to a core temperature of between −1° C. and −30° C. or lower and is irradiated in a microwave oven, the microwave energy will be primarily absorbed by the frozen available water. Whereas in conventional cooking heat is applied from the exterior, in microwave cooking heat is generated from within. The process of heating can be very rapid so that available water is converted into steam. When a food product is allowed to stand after heating in a microwave oven, water can continue to be expelled from the product. This is particularly noticeable for example when heating frozen fish muscle. The loss of water causes any food coating, particularly a batter, pastry or breadcrumb coating to become soggy and unpalatable. In addition the core of the substrate may become dry due to the loss of water.

Attempts have been made to limit the escape of moisture during microwave cooking by coating the product with a composition which forms an impermeable film This is unsatisfactory because the natural distribution of water within the coated product is lost through any coating as steam and due to internal pressure. Furthermore, an impenetrable coating or film is detrimental to the taste and mouth feel of the product.

### SUMMARY

A first aspect of the present disclosure includes a method of manufacture of a food product including wholly or partially impregnating a substrate with a stabilizer composition where the substrate is pieces of meat, poultry, fish, vegetable, fruit or dairy food. The stabilizer composition includes: 5 wt % to 30 wt % of one or more gums selected from the group consisting of one or more of carrageenan gums and optionally one or more of: locust bean gum; guar gum; xanthan gum, gellan gum, gum Arabic and agar agar, calculated by weight of dry matter; salt selected from sodium chloride, potassium chloride and combinations thereof in a concentration of 0 wt % to about 50 wt %, calculated by weight of dry matter; one or more polyglucose components selected from the group consisting of maltodextrin; polydextrose; starch and combinations thereof in a concentration of about 20 wt % to about 60 wt %, calculated by weight of dry matter; a phosphate component in a concentration of 0 wt % to about 7.4 wt %, calculated by weight of dry matter; and optional further edible ingredients in a concentration of 0 wt % (or about 0 wt %) to about 40 wt %, calculated by weight of dry matter where the concentration ranges given add up to total 100 wt %.

Yet another aspect of the present disclosure relates to a food product including a substrate impregnated with a stabilizer composition produced by a method in accordance with the present disclosure, including the method described above.

### DETAILED DESCRIPTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting, instead, the scope of the present invention will be established by the appended claims.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

In this specification and the appended claims, the singular forms “a,” “an” and “the” include plural reference unless the context clearly dictates otherwise.

The invention finds particular application with meat substrates, especially whole muscle or bone-in meat substrates. In particularly advantageous embodiments the substrate may comprise whole muscle meat, such as chicken breast. Alternatively, the substrate may include: bone-in chicken, leg or wing portions or meat chops.

The stabilizer composition may be provided as an aqueous composition, preferably with a dry matter content of about 20 wt % to about 40 wt %, more preferably about 30 wt % to about 35 wt %, typically about 30 wt % or about 34 wt %.

The aqueous stabilizer composition is preferably a free flowing or non-viscous liquid to facilitate penetration into the substrate by permeation or injection as described below.

The viscosity at 20° C. is preferably less than 1000 cP. The viscosity is preferably in the range 1 to 1950 cP, preferably 3 to 1000 cP measured using a Brookfield viscometer with a No. 63 spindle at 60 rpm at 20° C.

Alternatively, the viscosity may be in the range of 4 to 5 secs measuring using a DinCup at 20° C.

Preferred stabilizer compositions in accordance with this disclosure exhibit an advantageous combination of properties. While the viscosity is sufficiently low to permit administration to a substrate by pumping through the hollow needles of an injector, the compositions have excellent water binding and water retention properties. Water loss from an injected substrate is reduced, so that the substrate retains succulence on cooking or reheating from the frozen or chilled state. Water migration during frozen or chilled storage is reduced so that a crumb or batter coating remains crispy after storage for a longer period. Furthermore, the cooked or reheated product may be maintained in a heated state for a prolonged period between cooking and reheating and serving to a consumer. This facilitates large scale catering or application in transportation environments, for example, in aircraft in which serving and consumption of some of a batch of ingredients may be delayed.

Advantageous stabilizer compositions exhibit low viscosity and beneficial flow properties at temperatures below ambient temperatures such as may be encountered during processing of meat products, for example, in the range −4° C. to 25° C., preferably 0° C. to 20° C., more preferably 5° C. to 15° C.

The one or more gums are preferably present in a concentration, calculated by weight of dry matter, more preferably of about 8 wt % to about 18 wt %, even more preferably about 10 wt % to about 16 wt %, yet more preferably about 12 wt % to about 14 wt %, most preferably about 13 wt %.

The one or more gums preferably comprise a mixture of one or more carrageenan gums optionally together with an additional gum, for example locust bean gum or xanthan gum.

A mixture of kappa carrageenan gum and one or more additional gums is preferred, preferably a mixture of kappa carrageenan gum and one additional gum. The additional gum or gums may be selected from iota carrageenan gum, locust bean gum and xanthan gum. Iota carrageenan gum is particularly advantageous.

The choice of relative proportions of the gums used in a formulation influences the properties of the stabilizer composition. In addition to the low viscosity of the composition, any water should be strongly bound by the composition so that a minimum moisture loss can occur. When moisture passes from the gel into the substrate, for example, a chicken portion, or into a coating, for example, a crumb or batter layer, this can result in a product which is soggy and which has reduced crispness.

The preferred ratio of carrageenan gum to an additional gum selected from iota carrageenan gum, locust bean gum and mixtures thereof is in the range 75:25 to 50:50, preferably 75:25 to 60:40. Especially advantageous are mixtures of kappa carrageenan gum and iota carrageenan gum in the ratio 75:25 to 60:40, preferably 70:30 to 60:40, more preferably about 65:35 by weight.

A further advantageous combination of gums comprises kappa carrageenan gum and locust bean gum in a ratio from 75:25 to 50:50, preferably 75:25 to 55:45.

In an alternative embodiment, the one or more gums comprise a mixture of kappa carrageenan gum and iota carrageenan gum in a ratio by weight in the range of about 1:1 to about 5:1, preferably about 2:1 to about 4:1, more preferably about 3:1.

Besides the mixture of kappa carrageenan gum and iota carrageenan gum one or more further gums may be included in the stabilizer composition. For example one or more of: locust bean gum, xanthan gum, gum Arabic or agar agar may be used to increase the firmness of the gel foimed by the gum component.

Salt, when present, may be in a concentration of 10 wt % to 50 wt %, calculated by weight of dry matter, more preferably of about 20 wt % to about 40 wt %, even more preferably about 25 wt % to about 35 wt %, most preferably about 32 wt %, calculated by weight of dry matter. Preferably, the salt employed is sodium chloride or common salt.

The polyglucose component may serve as a filler and is preferably selected from the group consisting of maltodextrin; polydextrose and mixtures thereof. Especially preferred is maltodextrin. The polyglucose component is preferably present in the stabilizer composition in a concentration, calculated by weight of dry matter, of about 20 wt % to about 60 wt %, more preferably about 30 wt % to about 55 wt %, even more preferably about 32 wt % to about 55 wt %, most preferably 35 wt % to about 49 wt %. Use of the polyglucose additive helps to reduce the size of crystals formed when the impregnated product is frozen. It has been found that an undesirable reaction occurs when frozen products containing large crystals are reheated. Use of maltodextrin is preferred.

The preferred stabilizer compositions do not include gelatine. Use of gelatine is undesirable as it reacts with water on the surface of a meat or other substrate to form an undesirable sticky layer which would not promote adhesion of any coating layer to the substrate. Gelatine may also block the injector needles.

The phosphate component may be selected from the group consisting of (mono)phosphate, diphosphate, triphosphate, hexametaphosphate, polyphosphate and combination thereof. Preferably the phosphate component is a (mono)phosphate. A suitable mixture is sold under the trade mark Carnal 822. The phosphate component is preferably present in a concentration of 0 wt % to 7 wt %, calculated by weight of dry matter, more preferably of about 4.3 wt % to about 7.4 wt %, even more preferably about 5 wt % to about 7 wt %, more preferably about 6 wt % to about 7 wt %, most preferably about 6.5 wt %, calculated by weight of dry matter.

The composition may optionally further include cellulose ether, particularly for use with microwaveable food products.

Where present the cellulose ether concentration is preferably in the range of about 3 wt % to about 20 wt %, more preferably about 7 wt % to about 13 wt %, most preferably about 10 wt %, calculated by weight on dry matter. Preferably, the cellulose ether is methyl cellulose, for example, METHOCEL® A15.

The stabilizer composition is particularly advantageous with larger dimensioned substrates or bone-in substrates for which permeation into the substrate may be difficult to achieve, particularly when using the previously disclosed more viscous stabilizing compositions. Dilution of these compositions to reduce the viscosity also results in a loss of effective stabilization properties.

A particularly advantageous method may include the successive steps of:

a) impregnation;

b) tumbling, preferably vacuum tumbling;

c) application of pre-dust or fine crumb;

d) oven cooking;

e) freezing (optional);

f) application of pre-dust or fine crumb;

g) coating with a gel composition or flour containing batter;

h) application of a first crumb layer;

i) application of a second crumb layer (optional);

j) frying); and

k) freezing.

In preferred embodiments the step of partially or wholly impregnating the substrate may include the step of injecting the substrate with an array of hollow needles connected to a reservoir containing the stabilizer composition. A multiple needle injector may be employed. Side opening needles are preferably used, for example having a diameter of 2 mm.

Preferably the injector has an array of needles which are individually controllable using air pressure. Optiflex® needles may be used. The needles may be arranged in a fine pattern. A two stroke pattern may be used.

A preferred injector is manufactured under the registered trademark Gea AccuJector 450.

A minimum amount of the stabilizer composition is preferably impregnated into the substrate so that a minimum amount of water is introduced into the substrate.

The substrate is preferably impregnated with an amount of stabilizer composition of 5 wt % to 15 wt %, typically about 10 wt % by the weight of the stabilized substrate.

For bone-in products and other products, following impregnation, the substrate pieces may be tumbled in a tumble mixer until they are dry. A vacuum tumbler may be used in order to improve penetration into the substrate. The time taken to obtain dry substrate pieces may vary dependent on the nature of the substrate. Larger pieces for example, chicken fillets or drumsticks with a weight about 125 g may be tumbled for up to and including 30 minutes. Smaller pieces with weights about 50-75 g may be tumbled for from 20 to 25 minutes. Tumbling for larger periods is not preferred due to possible protein extraction from the meat.

When the tumbled substrate pieces are dry, a pre-dust may be applied. The pre-dust may be a conventional seasoned flour composition.

Preferably, the pre-dust comprises a water resistant powdered crumb resultant from milling crumb which has been extruded with guar gum, xanthan gum or other hydrocolloid, as disclosed in WO2010/001101, the disclosure of which is incorporated into this specification by reference in its entirety and for all purposes.

The pre-dust may have a particle size less than 0.8 mm.

The pre-dust coated product is preferably fully cooked, typically using a thermal oven, for example a Gea Cookstar (Registered Trademark) oven having a conveyor speed of about 2 m/second at 160° C. for about 20 minutes, dependent on the size and nature of the product.

For bone-in products, preferably a minimum core temperature of 85° C. is achieved to prevent occurrence of bloodspots.

The cooked product may be frozen and is preferably introduced into a freezer before the core temperature of the substrate falls below 65° C., preferably 70° C. The process is disclosed in WO2012/101025, the disclosure of which is incorporated into this specification by reference in its entirety for all purposes. A gyro freezer at −40° C. may be used. The freezing time may be 35 minutes using a conveyor speed of 2.0 m/second. A core temperature of −10° C. or less should be achieved within a period of 5 minutes, preferably within a period of 2 minutes after removal from the oven. The products may be stored at −20° C. or at a higher temperature such as −4° C.

A predust consisting of a powder or fine particulate coating is preferably applied to the tmepered stabilized substrate pieces, for example at −2° C. and 2° C. The composition of the coating may depend on the nature of the intended heating process.

For an ovenable coating system, the coating may comprise a pre-dust consisting of

| Ingredient | % |
|---|---|
| fine breadcrumbs, less than 0.8 mm | 59 |
| wheat starch (Briljant) (RTM) | 40 |
| vegetable oil | 1 |
| Total | 100 |

The crumb may be a gum impregnated crumb manufactured in accordance with the disclosure of WO2010/001101, the entire disclosure of which is hereby incorporated by reference.

The pre-dust coated frozen substrate is preferably coated with an aqueous gel-like coating solution using a tempura applicator. The composition of the solution (referred to as PD8) was:

| Ingredient | % |
|---|---|
| cellulose gum (Methocel A4M) (RTM) | 25.0 |
| modified starch (Thermflo) | 35.0 |
| xanthan gum | 25.0 |
| egg albumen | 15.0 |
| Total | 100.0 |

Alternatively, a standard flour containing batter composition may be employed.

The gel coated substrate pieces may be coated with a first layer of gum impregnated crumb manufactured in accordance with WO2010/001101 and having a dimension from 1.5 mm to 2.5 mm or 2.0 mm to 3.15 mm, typically followed by a second infill coating of crumb with a size range of 0.8 mm to 1.5 mm or 0.8-2.0 mm.

The crumb coated product preferably is fried, e.g. in hot oil at 180° C. for 2 minutes, and frozen at −40° C. using a Gyro freezer. The frozen products may be packaged for storage and distribution.

For a microwavable coating system the frozen cooked products may be coated with an aqueous solution comprising 1% PD8 (mentioned above) following which a first crumb coating with a size less than 0.8 mm may be applied followed by a further application of aqueous coating and successive applications of crumb with a dimension from 2.0 mm to 3.15 mm and 0.8 mm to 2.0 mm. The crumb coated product may be fried at 180° C. for 2 minutes 30 seconds followed by cryogenic freezing and packaging.

For chicken fillets a similar process may be used with injection followed by tumbling until dry, following which the product may be allowed to rest overnight before cooking and freezing as described above.

The products manufactured in accordance with the process described above are crispy and have succulent meat.

A soya batter may be used in place of the PD8 for ovenable products.

The invention is further described by means of example, but not in any limitative sense.

### EXAMPLE 1

A stabilizer composition was prepared by mixing the following ingredients:

| | |
|---|---|
| kappa carrageenan gum/iota carrageenan | 13% |
| gum mixture 65:35 w/w | |
| sodium chloride | 32% |
| maltodextrin | 38.5% |
| sodium phosphate (Carnal 822) (RTM) | 6.5% |
| methyl cellulose (Methocel A15) (RTM) | 10% |
| Total | 100% |

The mixture was dissolved in water to form a solution having a solids content of 34 wt % and a viscosity at 20° C. of 450 cP to 550 cP measured using a Brookfield viscometer with a No 63 spindle.

20 chicken fillets each having a weight of 125 g were placed in a Gea AccuJector® 450 injector and were injected with the stabilizer solution until a weight increase of 10% was obtained. Following the injection the chicken pieces were placed in a tumble mixer and tumbled for 30 minutes. After this period the pieces had a dry appearance.

A predust was prepared using water resistant dust (particle size <0.8 mm) obtained by milling crumb manufactured in accordance with WO2010/001101 and dried to a water content of 1.5 wt %. The impregnated chicken pieces were coated with the predust.

The predust (<0.8 mm) coated chicken pieces were cooked at 160° C. for about 20 minutes in a Gea Cookstar® conveyor oven having a conveyor speed of 2 m/sec.

The cooked chicken pieces were removed from the oven and were immediately placed into a giro freezer maintained at −40° C. The period between removal from the oven and insertion into the freezer was 1.5 minutes or less. The freezing time was 35 minutes and the conveyor speed was 2 m/sec. The core temperature of the product after freezing for two minutes was determined to be −20° C. or lower.

A predust coating was applied to the frozen pieces. The predust consisted of

| Ingredient | % |
|---|---|
| fine breadcrumbs, less than 0.8 mm | 59%; |
| wheat starch (Briljant) (RTM) | 40%; |
| vegetable oil | 1%. |
| Total | 100% |

The predust coated pieces were passed through a tempura applicator containing an aqueous coating composition (fully hydrated gel) that was prepared using a powder mixture consisting of:

| Ingredient | % |
|---|---|
| Modified starch (Thermflo) (RTM) | 35 |
| Thickener Methocel A4M (RTM) | 25 |
| Xanthan gum | 25 |
| Egg albumen | 15 |
| Total | 100 |

The powder mixture was dissolved in water to form a 1% solution, and was left to stand for minimum 1 hour to form a fully hydrated gel.

The pickup of the gel composition was about 6% to 8%. The gel coated pieces were then fried at 180° C. for 2 minutes 30 seconds followed by freezing and packaging. Cryogenic freezing is used for microwaveable products. Ovenable products are fried for two minutes before freezing.

What is claimed is:

1. A method of manufacture of a food product comprising the step of wholly or partially impregnating a substrate with a stabilizer composition;
wherein the substrate comprises pieces of: meat, poultry, fish, vegetable, fruit or dairy food;
wherein the stabilizer composition comprises the following ingredients:
5 wt % to 30 wt % of one or more gums selected from the group consisting of one or more carrageenan gums and optionally one or more of: locust bean gum; guar gum; xanthan gum, gellan gum, gum Arabic and agar agar, calculated by weight of dry matter;
salt selected from sodium chloride, potassium chloride and combinations thereof in a concentration of about 0 wt % to about 50 wt %, calculated by weight of dry matter;
one or more polyglucose components selected from the group consisting of maltodextrin; polydextrose; starch and combinations thereof in a concentration of about 20 wt % to about 60 wt %, calculated by weight of dry matter;
a phosphate component in a concentration of about 0 wt % to about 7.4 wt %, calculated by weight of dry matter; and
optional further edible ingredients in a concentration of 0 wt % to 40 wt %, calculated by weight of dry matter;
wherein the concentration ranges given add up to total 100 wt %.

2. The method of claim 1, wherein the stabilizer composition is an aqueous composition with a dry matter content from about 20 wt % to about 40 wt %.

3. The method of claim 1, wherein the stabilizer composition is an aqueous composition with a dry matter content from about 30 wt % to about 35 wt %.

4. The method of claim 3, wherein the substrate is whole muscle or bone-in meat.

5. The method of claim 1, wherein the substrate is whole muscle or bone-in meat.

6. The method of claim 4, wherein the one or more gums are present in a concentration, calculated by weight of dry matter, of from about 8 wt % to about 18 wt %.

7. The method of claim 6, wherein the one or more gums comprise a mixture of kappa carrageenan gum and iota carrageenan gum.

8. The method of claim 7, wherein the weight ratio of kappa carrageenan gum to iota carrageenan gum is in the range of about 75:25 to 60:40.

9. The method of claim 7, wherein the weight ratio of kappa carrageenan gum to iota carrageenan gum is in the range 70:30 to 60:40.

10. The method of claim 7, wherein the weight ratio of kappa carrageenan gum to iota carrageenan gum is about 65:35.

11. The method of claim 7, wherein the polyglucose component is maltodextrin

12. The method of claim 11, wherein the polyglucose component is present in a concentration, calculated by weight of dry matter, in the range from about 30 wt % to about 55 wt.

13. The method of claim 12, wherein the stabilizer composition contains from about 3 to about 30 wt % of cellulose ether, calculated by weight of dry matter.

14. The method of claim 13, wherein the step of impregnating the substrate with a stabilizer composition comprises injecting the substrate with the stabilizer composition, using a multiple needle injector.

15. The method of claim 14, wherein the substrate is impregnated with form about 5 wt % to about 15 wt % of the aqueous stabilizer composition, calculated by weight of the stabilized substrate.

16. The method of claim 13 further comprising the step of tumbling the impregnated substrate until the exterior of the substrate is dry.

17. The method as claimed in claim 16, wherein the tumbling is vacuum tumbling.

18. The method of claim 1 further comprising the successive steps of:
a) impregnation;
b) tumbling, preferably vacuum tumbling;
c) application of pre-dust or fine crumb;
d) oven cooking;
e) freezing (optional);
f) application of pre-dust or fine crumb;
g) coating with a gel composition or flour containing batter;
h) application of a first crumb layer;
i) application of a second crumb layer (optional);
j) frying) and
k) freezing.

19. A stabilizer composition comprising:
from about 5 wt % to about 30 wt % of one or more gums selected from the group consisting of one or more carrageenan gums and optionally one or more of: locust bean gum; guar gum; xanthan gum, gellan gum, gum Arabic and agar agar, calculated by weight of dry matter;
salt selected from sodium chloride, potassium chloride and combinations thereof in a concentration of about 0 wt % to about 50 wt %, calculated by weight of dry matter;
one or more polyglucose components selected from the group consisting of maltodextrin; polydextrose; starch and combinations thereof in a concentration of about 20 wt % to about 60 wt %, calculated by weight of dry matter;
a phosphate component in a concentration of about 0 wt % to about 7.4 wt %, calculated by weight of dry matter; and
optional further edible ingredients in a concentration of 0 wt % to 40 wt %, calculated by weight of dry matter; wherein the concentration ranges given add up to total 100 wt %.

20. A food product comprising an edible substrate impregnated with a stabilizer composition using the method of claim 1.
